(19) United States
(12) Patent Application Publication
(10) Pub. No.: US 2015/0310622 A1
(43) Pub. Date: Oct. 29, 2015

(54) Depth Image Generation Utilizing Pseudoframes Each Comprising Multiple Phase Images

(71) Applicant: Avago Technologies General IP (Singapore) Pte. Ltd., Singapore (SG)

(72) Inventors: Alexander Borisovich Kholodenko, Moscow (RU); Barrett J. Brickner, Savage, MN (US); Denis Vladimirovich Zaytsev, Dzerzhinsky (RU); Denis Vasilyevich Parfenov, Moscow (RU); Alexander Alexandrovich Petyushko, Bryansk (RU)

(21) Appl. No.: 14/676,282

(22) Filed: Apr. 1, 2015

(30) Foreign Application Priority Data
Apr. 24, 2014 (RU) 2014116610

(51) Int. Cl. G06T 7/00

(52) U.S. Cl. CPC G06T 7/0075

(57) ABSTRACT

In one embodiment, an image processor is configured to obtain phase images, and to group the phase images into pseudoframes with each of at least a subset of the pseudoframes comprising multiple ones of the phase images and having as a first phase image thereof one of the phase images that is not a first phase image of an associated depth frame. A velocity field is estimated by comparing corresponding phase images in respective ones of the pseudoframes. Phase images of one or more pseudoframes are modified based at least in part on the estimated velocity field, and one or more depth images are generated based at least in part on the modified phase images. By way of example, different groupings of the phase images into pseudoframes may be used for each obtained phase image, allowing depth images to be generated at much higher rates than would otherwise be possible.

### FIELD

The field relates generally to image processing, and more particularly to techniques for generating depth images.

### BACKGROUND

Depth images are commonly utilized in a wide variety of machine vision applications including, for example, gesture recognition systems and robotic control systems. A depth image may be generated using a depth imager such as a structured light (SL) camera or a time of flight (ToF) camera. Such cameras may provide both depth information and intensity information, in the form of respective depth and amplitude images.

Certain types of depth imagers, such as ToF cameras, generate depth images using sequences of phase images captured at different instants in time. Accordingly, multiple phase images associated with a common depth frame are captured by the depth imager in order to generate a single depth image. In a typical arrangement, a set of two, four or even more phase images is utilized in generating each depth image. This unduly limits the depth frame rate achievable by the depth imager to a fraction of the phase image capture rate of the depth imager.

### SUMMARY

In one embodiment, an image processor is configured to obtain phase images, and to group the phase images into pseudoframes with each of at least a subset of the pseudoframes comprising multiple ones of the phase images and having as a first phase image thereof one of the phase images that is not a first phase image of an associated depth frame. A velocity field is estimated by comparing corresponding phase images in respective ones of the pseudoframes. Phase images of one or more pseudoframes are modified based at least in part on the estimated velocity field, and one or more depth images are generated based at least in part on the modified phase images.

By way of example only, different groupings of the phase images into pseudoframes may be used for each obtained phase image, allowing depth images to be generated at much higher rates than would otherwise be possible.

As a more particular example, in some embodiments, such as those in which independent clocks are used for phase image capture and depth image computation, depth images can be generated at an output frame rate that is multiple times higher than an input frame rate associated with phase image acquisition.

The image processor may be implemented in a depth imager such as a ToF camera or in another type of processing device.

Other embodiments of the invention include but are not limited to methods, apparatus, systems, processing devices, integrated circuits, and computer-readable storage media having computer program code embodied therein.

### BRIEF DESCRIPTION OF THE DRAWINGS

FIG. 1 is a block diagram of a depth imager comprising an image processor configured to generate depth images utilizing pseudoframes in an illustrative embodiment.

FIG. 2 is a flow diagram of an illustrative embodiment of a depth image generation process implemented in the image processor of FIG. 1.

FIG. 3 illustrates an exemplary sequence of phase images processed by a depth imager in an illustrative embodiment.

FIGS. 4A and 4B illustrate exemplary groupings of the FIG. 3 phase images into pseudoframes.

FIG. 5 shows another illustrative embodiment in which depth images are generated utilizing pseudoframes.

### DETAILED DESCRIPTION

Embodiments of the invention will be illustrated herein in conjunction with exemplary depth imagers that include respective image processors each configured to generate depth images utilizing pseudoframes. It should be understood, however, that embodiments of the invention are more generally applicable to any image processing system or associated device or technique in which it is desirable to generate depth images at an increased frame rate relative to conventional arrangements.

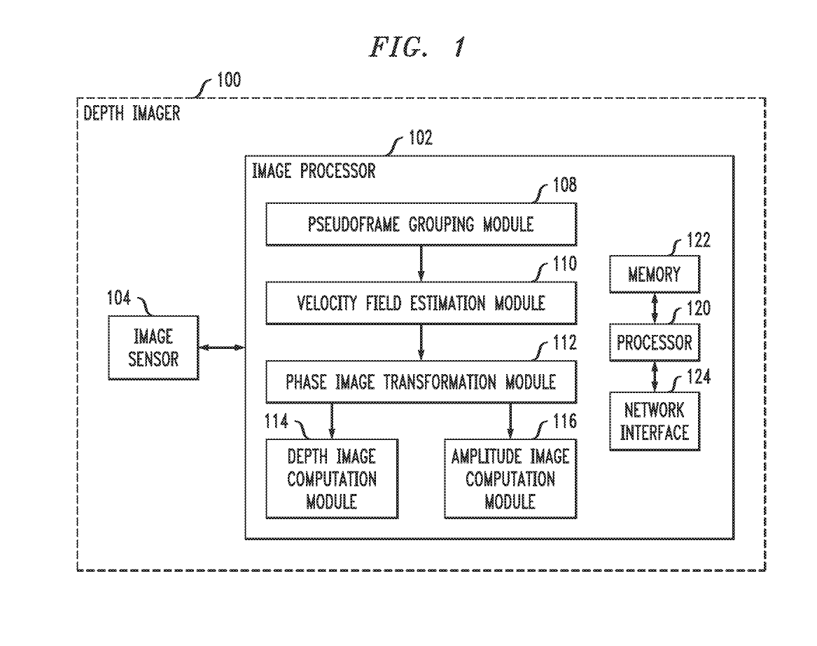

FIG. 1 shows a depth imager 100 in an embodiment of the invention. The depth imager 100 comprises an image processor 102 that receives raw depth images from an image sensor 104. Although illustrated as a stand-alone device in the figure, the depth imager 100 is assumed to be part of a larger image processing system. For example, the depth imager 100 is generally configured to communicate with a computer or other processing device of such a system over a network or other type of communication medium.

Accordingly, depth images generated by the depth imager 100 can be provided to other processing devices for further processing in conjunction with implementation of functionality such as gesture recognition. Such depth images can additionally or alternatively be displayed, transmitted or stored using a wide variety of conventional techniques.

Moreover, the depth imager 100 in some embodiments may be implemented on a common processing device with a computer, mobile phone or other device that processes depth images. By way of example, a computer or mobile phone may be configured to incorporate the image processor 102 and image sensor 104.

The depth imager 100 in the present embodiment is more particularly assumed to be implemented in the form of a ToF camera configured to generate depth images using the pseudoframe techniques disclosed herein, although other implementations such as an SL camera implementation or a multiple 2D camera implementation may be used in other embodiments. A given depth image generated by the depth imager 100 may comprise not only depth data but also intensity or amplitude data with such data being arranged in the form of one or more rectangular arrays of pixels.

The image processor 102 of depth imager 100 illustratively comprises a pseudoframe grouping module 108, a velocity field estimation module 110, a phase image transformation module 112, a depth image computation module 114 and an amplitude image computation module 116. The image processor 102 is configured to obtain from the image sensor 104 a sequence of phase images. The phase images are captured by the image sensor 104 at a phase image capture rate. The image processor 102 processes the phase images utilizing pseudoframes in a manner that advantageously allows depth images to be generated at a faster rate than would otherwise be possible if the phase images were strictly processed based on their association with particular depth frames.

As noted above, in conventional depth imagers such as ToF cameras, a set of four phase images associated with a common depth frame is typically utilized in generating each depth image. Accordingly, although the ToF camera can capture phase images at a relatively high rate, it generates depth images at a relatively low rate, and more particularly at a maximum rate that is approximately one-fourth the phase image capture rate in arrangements in which each depth frame comprises a set of four phase images.

The present embodiment overcomes this drawback of conventional practice by grouping the phase images into pseudoframes in the pseudoframe grouping module 108. This allows operations such as velocity field estimation and phase image transformation in respective modules 110 and 112 to occur much more frequently than would otherwise be possible if the phase images were processed in the form of complete depth frames.

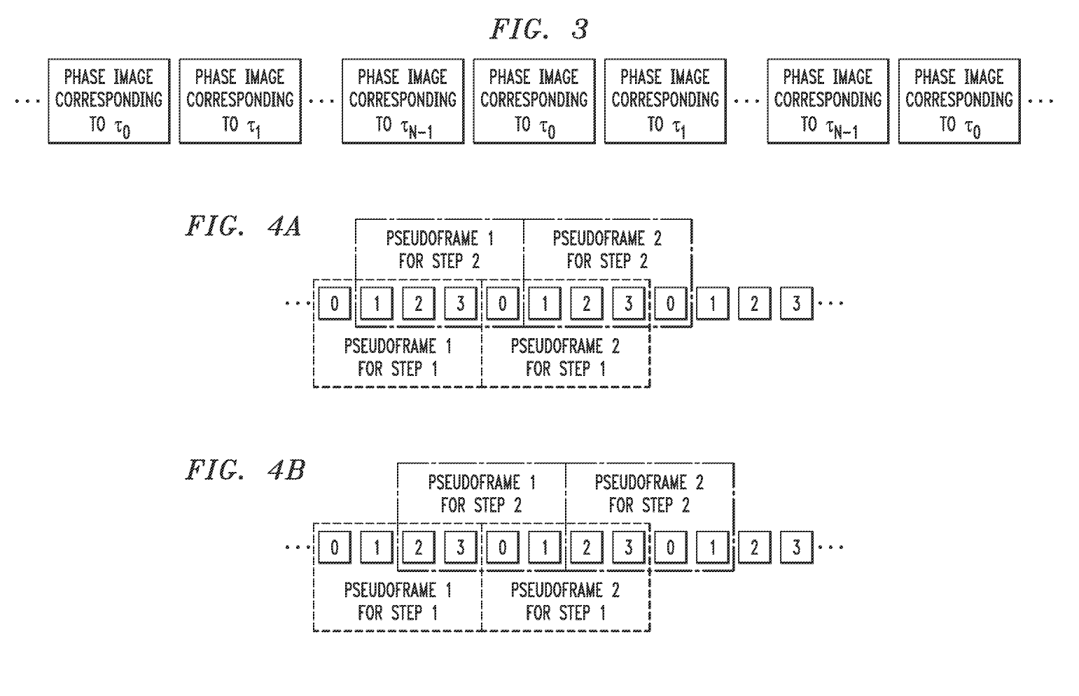

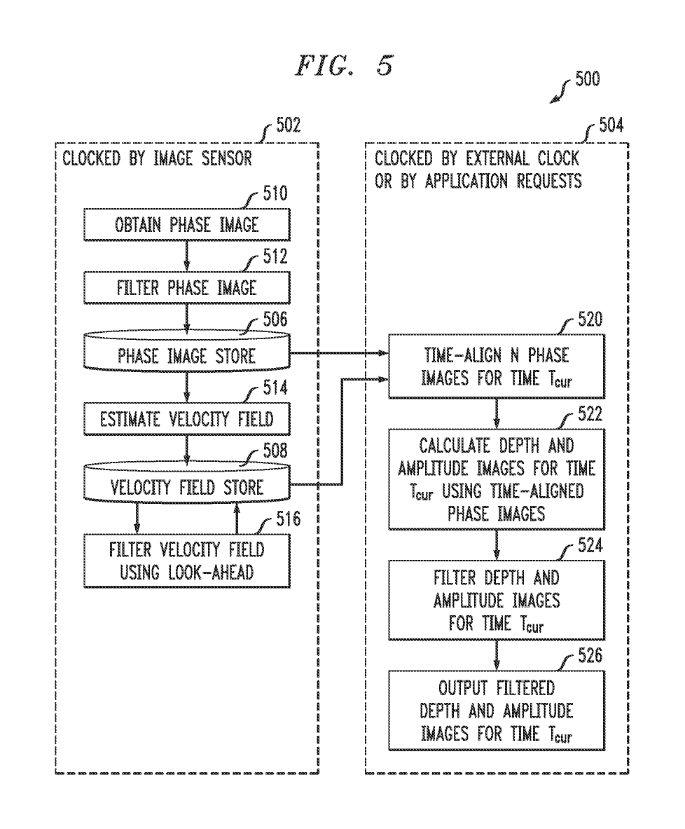

In the grouping of the phase images into pseudoframes in module 108, the conventional depth frame boundaries are essentially ignored. Thus, for example, each of at least a subset of the pseudoframes includes multiple phase images and has as a first phase image thereof one of the phase images that is not a first phase image of an associated depth frame. More detailed examples of phase images and possible groupings of phase images into pseudoframes using the module 108 will be described below in conjunction with FIGS. 3, 4A and 4B.

The image processor 102 is configured to perform phase image processing operations utilizing pseudoframes. Thus, for example, velocity fields can be estimated in module 110 by comparing corresponding phase images in respective consecutive ones of the pseudoframes, and depth images can be generated using modules 112 and 114 taking into account the estimated velocity fields from module 110. The term “velocity field” as used herein is intended to be broadly construed, so as to encompass, for example, point velocities determined for respective points of an imaged scene between the consecutive pseudoframes. A velocity field may be computed over all or a subset of a plurality of pixels of multiple phase images, and the phase images used to compute a velocity field need not be consecutive.

As a more specific example, estimating a velocity field illustratively comprises, for each of a plurality of pixels of a given one of the phase images of a first one of the pseudoframes, determining an amount of movement of a point of an imaged scene between the pixel of the given phase image of the first pseudoframe and a pixel of a corresponding phase image of a second one of the pseudoframes. More particularly, determining an amount of movement illustratively comprises determining a velocity (Vₓ, V_{y}) of a point of the imaged scene corresponding to pixel (x,y) of the given phase image. Numerous other techniques for generating velocity fields can be used in other embodiments.

The term “point” as used herein in the context of an imaged scene may refer to any identifiable feature or characteristic of the scene, or portion of such a feature or characteristic, for which movement can be tracked across multiple phase images.

The image processor 102 utilizes modules 112 and 114 to generate depth images based on initial phase images provided by the image sensor 104 while also taking into account the estimated velocity fields determined by velocity field estimation module 110. For example, the phase image transformation module 112 can be used to adjust pixel values of respective other phase images of a pseudoframe based on a determined amount of movement, and the depth image computation module 114 can generate a depth image utilizing at least a subset of the given phase image and the adjusted other phase images of the pseudoframe. In conjunction with generation of the depth image in module 114, a corresponding amplitude image may be generated in amplitude image computation module 116, also utilizing the given phase image and the adjusted other phase images of the pseudoframe.

Adjusting pixel values of respective other phase images of the pseudoframe in some embodiments comprises transforming the other phase images such that the point of the imaged scene has substantially the same pixel coordinates in each of the phase images of the pseudoframe. Such adjustment provides motion compensation of the type described in PCT International Application PCT/RU13/000921, filed on Oct. 18, 2013 and entitled “Motion Compensation Method and Apparatus for Depth Images,” which is commonly assigned herewith and incorporated by reference herein.

For example, pixel values can be adjusted by moving values of the pixels of respective other phase images of the pseudoframe to positions within those images corresponding to a position of the pixel in the given phase image of the pseudoframe. Such movement of the pixel values can create gaps corresponding to “empty” pixels, also referred to herein as “missed” pixels. For any such missed pixels that result from movement of the corresponding pixel values, the corresponding gaps can be filled or otherwise repaired by assigning replacement values to the pixels for which values were moved. The assignment of replacement values may be implemented, for example, by assigning the replacement values as predetermined values, by assigning the replacement values based on values of corresponding pixels in a phase image of at least one previous or subsequent pseudoframe, or by assigning the replacement values as a function of a plurality of neighboring pixel values within the same phase image. Various combinations of these and other assignment techniques may also be used.

The movement determining and pixel value adjusting operations mentioned above may be repeated for substantially all of the pixels of the given phase image that are associated with a particular object of the imaged scene. This subset of the set of total pixels of the given phase image may be determined based on definition of a particular region of interest (ROI) within that phase image. It is also possible to repeat the movement determining and pixel value adjusting operations for substantially all of the pixels of the given phase image.

Other arrangements can be used in other embodiments. For example, the movement may be determined relative to arbitrary moments in time and all of the phase images can be adjusted based on the determined movement.

The resulting depth image and its associated amplitude image is then subject to additional processing operations in the image processor 102 or in another processing device. Such additional processing operations may include, for example, storage, transmission or further image processing of the depth image and associated amplitude image.

It should be noted that the term “depth image” as broadly utilized herein may in some embodiments encompass an associated amplitude image. Thus, a given depth image may comprise depth data as well as corresponding amplitude data. For example, the amplitude data may be in the form of a grayscale image or other type of intensity image that is generated by the same image sensor 104 that generates the depth data. An intensity image of this type may be considered part of the depth image itself, or may be implemented as a separate intensity image that corresponds to or is otherwise associated with the depth image. Other types and arrangements of depth images comprising depth data and having associated amplitude data may be generated in other embodiments.

Accordingly, references herein to a given depth image should be understood to encompass, for example, an image that comprises depth data only, as well as an image that comprises a combination of depth and amplitude data. The depth and amplitude images mentioned previously in the context of the description of modules 114 and 116 need not comprise separate images, but could instead comprise respective depth and amplitude portions of a single image.

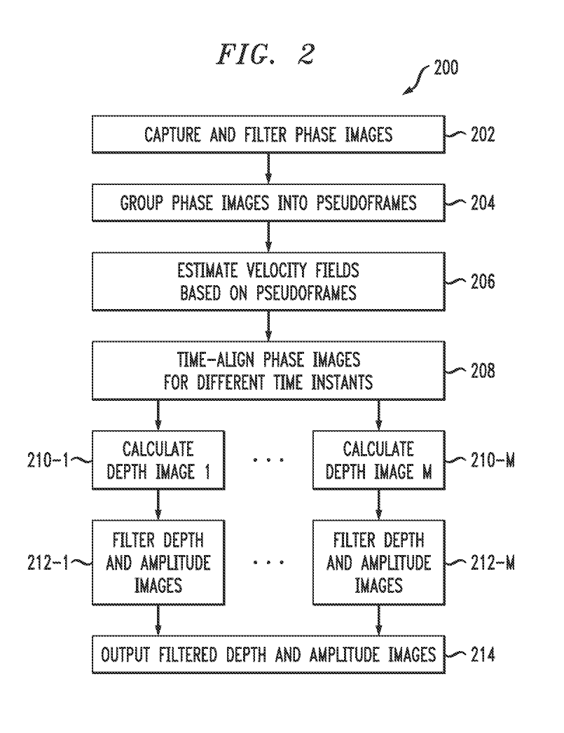

Examples of processing operations and other features or functionality associated with the modules 108, 110, 112, 114 and 116 of image processor 102 will be described in greater detail below in conjunction with FIGS. 2 through 5.

The particular number and arrangement of modules shown in image processor 102 in the FIG. 1 embodiment can be varied in other embodiments. For example, in other embodiments two or more of these modules may be combined into a lesser number of modules, or the disclosed depth image generation functionality may be distributed across a greater number of modules. An otherwise conventional image processing integrated circuit or other type of image processing circuitry suitably modified to perform processing operations as disclosed herein may be used to implement at least a portion of one or more of the modules 108, 110, 112, 114 and 116 of image processor 102.

Depth and amplitude images generated by the respective computation modules 114 and 116 of the image processor 102 may be provided to one or more other processing devices or image destinations over a network or other communication medium. For example, one or more such processing devices may comprise respective image processors configured to perform additional processing operations such as feature extraction, gesture recognition and automatic object tracking using depth and amplitude images that are received from the image processor 102. Alternatively, such operations may be performed in the image processor 102.

The image processor 102 in the present embodiment is assumed to be implemented using at least one processing device and comprises a processor 120 coupled to a memory 122. The processor 120 executes software code stored in the memory 122 in order to control the performance of image processing operations, including operations relating to grouping phase images into pseudoframes, estimating velocity fields using the pseudoframes, transforming or otherwise modifying phase images based at least in part on the estimated velocity fields, and generating depth images based at least in part on the modified phase images. As used herein, operations that are performed “based at least in part” on certain types of information may but need not utilize other types of information.

The image processor 102 in this embodiment also illustratively comprises a network interface 124 that supports communication over a network, although it should be understood that an image processor in other embodiments of the invention need not include such a network interface. Accordingly, network connectivity provided via an interface such as network interface 124 should not be viewed as a requirement of an image processor configured to generate depth images as disclosed herein.

The processor 120 may comprise, for example, a microprocessor, an application-specific integrated circuit (ASIC), a field-programmable gate array (FPGA), a central processing unit (CPU), an arithmetic logic unit (ALU), a digital signal processor (DSP), or other similar processing device component, as well as other types and arrangements of image processing circuitry, in any combination.

The memory 122 stores software code for execution by the processor 120 in implementing portions of the functionality of image processor 102, such as portions of modules 108, 110, 112, 114 and 116. A given such memory that stores software code for execution by a corresponding processor is an example of what is more generally referred to herein as a computer-readable medium or other type of computer program product having computer program code embodied therein, and may comprise, for example, electronic memory such as random access memory (RAM) or read-only memory (ROM), magnetic memory, optical memory, or other types of storage devices in any combination.

Articles of manufacture comprising such computer-readable storage media are considered embodiments of the invention. The term “article of manufacture” as used herein should be understood to exclude transitory, propagating signals.

It should also be appreciated that embodiments of the invention may be implemented in the form of integrated circuits. In a given such integrated circuit implementation, identical die are typically formed in a repeated pattern on a surface of a semiconductor wafer. Each die includes an image processor or other image processing circuitry as described herein, and may include other structures or circuits. The individual die are cut or diced from the wafer, then packaged as an integrated circuit. One skilled in the art would know how to dice wafers and package die to produce integrated circuits. Integrated circuits so manufactured are considered embodiments of the invention.

The particular configuration of depth imager 100 as shown in FIG. 1 is exemplary only, and the depth imager 100 in other embodiments may include other elements in addition to or in place of those specifically shown, including one or more elements of a type commonly found in a conventional implementation of such an imager.

For example, in some embodiments, the depth imager 100 may be installed in a video gaming system or other type of gesture-based system that processes image streams in order to recognize user gestures. The disclosed techniques can be similarly adapted for use in a wide variety of other systems requiring a gesture-based human-machine interface, and can also be applied to applications other than gesture recognition, such as machine vision systems in robotics and other industrial applications.

Referring now to FIG. 2, an exemplary flow diagram is shown illustrating a depth image generation process 200 implemented in the depth imager 100. The process includes steps 202 through 214 as shown. Step 202 is assumed to be implemented by the image sensor 104. Steps 204 and 206 are assumed to be performed by respective modules 108 and 110 of the image processor 102. Steps 208, 210, 212 and 214 are assumed to be performed at least in part utilizing the phase image transformation module 112, depth image computation module 114 and amplitude image computation module 116. As indicated previously, portions of the process may be implemented at least in part utilizing software executing on image processing hardware of the image processor 102.

It is further assumed in this embodiment that the image sensor 104 generates phase images that are provided to the image processor 102. The phase images are generally associated with depth frames but are processed by the image processor 102 in the form of pseudoframes that do not utilize the same framing as the depth frames. The pseudoframes are assumed to comprise respective sequences of a fixed number N of consecutive phase images each having a different capture time, but the particular phase images that make up a given pseudoframe can be associated with different depth frames. The fixed number N of consecutive phase images in a given pseudoframe is equal to the number of phase images in a given depth frame. By way of example, in some embodiments N=4, although other values of N can be used.

In step 202, phase images are captured and filtered by the image sensor 104.

Additionally or alternatively, the phase images captured by the image sensor 104 may be filtered in the image processor 102.

In step 204, the phase images are grouped into pseudoframes.

In step 206, velocity fields are estimated based on the pseudoframes.

It should be noted that steps 202, 204 and 206 can be performed substantially continuously as phase images are generated by the image sensor 104. Thus, for example, a different grouping of phase images into pseudoframes and corresponding estimated velocity field can be determined for each new phase image that is captured by the image sensor 104.

In step 208, phase images are time-aligned for different time instants utilizing the estimated velocity fields. By way of example, phase images of a given pseudoframe can be time-aligned by adjusting pixel values of at least a subset of those phase images based on the corresponding velocity field such that all of the phase images substantially correspond to a particular single time instant, in accordance with the motion compensation techniques described in the above-cited PCT International Application PCT/RU13/000921. Accordingly, time-aligning of phase images illustratively involves, for example, modifying at least a subset of the phase images of a given pseudoframe such that each phase image of the given pseudoframe appears as if it were captured at substantially the same instant in time. These and other types of phase image modifications are intended to be encompassed by general references herein to “modifying” of phase images based at least in part on an estimated velocity field.

In steps 210-1 through 210-M, different depth images are calculated using the respective different sets of time-aligned phase images. Accordingly, up to M different depth images can be calculated, each based on a different set of time-aligned phase images determined using an estimated velocity field. In addition to the depth images, up to M corresponding amplitude images can be calculated in these steps.

In steps 212-1 through 212-M, respective ones of the M different pairs of depth and amplitude images are filtered. This may involve, for example, use of smoothing filters, bilateral filters, or other types of filters. Such filtering is not a requirement, and can be eliminated in other embodiments.

In step 214, the resulting filtered depth and amplitude images are output by the image processor 102.

The time aligning, calculating, filtering and outputting in respective steps 208, 210, 212 and 214 can be performed substantially continuously as new phase images are captured by the image sensor 104 or in response to requests from an application for a depth image associated with a particular time instant.

Also, at least a subset of the steps of the process 200 can be performed in a pipelined manner or otherwise in parallel with one another rather than being performed sequentially as illustrated in the figure.

As noted above, the depth imager 100 is assumed to utilize ToF techniques to generate depth images. In some embodiments, the ToF functionality of the depth imager is implemented utilizing a light emitting diode (LED) light source which illuminates an imaged scene. Distance is measured based on the time difference between the emission of light onto the scene from the LED source and the receipt at the image sensor 104 of corresponding light reflected back from objects in the scene. Using the speed of light, one can calculate the distance to a given point on an imaged object for a particular pixel as a function of the time difference between emitting the incident light and receiving the reflected light. More particularly, distance d to the given point can be computed as follows:

$$d = \frac{Tc}{2}$$

where T is the time difference between emitting the incident light and receiving the reflected light, c is the speed of light, and the constant factor 2 is due to the fact that the light passes through the distance twice, as incident light from the light source to the object and as reflected light from the object back to the image sensor.

The time difference between emitting and receiving light may be measured, for example, by using a periodic light signal, such as a sinusoidal light signal or a triangle wave light signal, and measuring the phase shift between the emitted periodic light signal and the reflected periodic signal received back at the image sensor.

Assuming the use of a sinusoidal light signal, the depth imager 100 can be configured, for example, to calculate a correlation function c(τ) between input reflected signal s(t) and output emitted signal g(t) shifted by predefined value τ, in accordance with the following equation:

$$c ( τ ) = {lim}_{T -> ∞} \frac{1}{T} {\int }_{T \text{/} 2}^{- T \text{/} 2} s ( t ) g ( t + τ ) d t .$$

In such an embodiment, a given depth frame more particularly comprises multiple phase images corresponding to respective predefined phase shifts τₙ given by n π/2, where n=0, . . . , N−1. This is illustrated in FIG. 3, which shows an exemplary sequence of phase images processed by depth imager 100 in one embodiment. The sequence of phase images comprises a phase image corresponding to τ₀, a phase image corresponding to τ₁, continuing up to a phase image corresponding to τ_{N-1}, all associated with a first depth frame. The sequence then includes another phase image corresponding to τ₀, another phase image corresponding to τ₁, continuing up to another phase image corresponding to τ_{N-1}, all associated with a second depth frame. The sequence continues in a similar manner with additional sets of N phase images associated with respective depth frames.

Each of the phase images associated with the first depth frame corresponds to another phase image in the same position in the second depth frame. Such corresponding phase images in consecutive depth frames generally appear similar to one another, although different phase images in the same depth frame can appear dissimilar to one another.

As indicated previously, in a typical arrangement there are N=4 phase images associated with each depth frame. Assuming that N=4, in order to compute depth and amplitude values for a given image pixel, the depth imager obtains four correlation values (A₀, . . . , A₃), where Aₙ=c(τₙ), and uses the following equations to calculate phase shift φ and amplitude a:

$$ϕ = arctan ( \frac{{A}_{3} - {A}_{1}}{{A}_{0} - {A}_{2}} ) , a = \frac{1}{2} \sqrt{{( {A}_{3} - {A}_{1} )}^{2} + {( {A}_{0} - {A}_{2} )}^{2} .}$$

The phase images in this embodiment comprise respective sets of A₀, A₁, A₂ and A₃ correlation values computed for a set of image pixels. The above formulas can be extended in a straightforward manner to arbitrary values of N. Using the phase shift φ, distance d can be calculated for a given image pixel as follows:

$$d = \frac{c}{4 πω} ϕ ,$$

where ω is the frequency of emitted signal and c is the speed of light. These computations are repeated to generate depth and amplitude values for other image pixels.

The correlation function above is computed over a specified integration time, which may be on the order of about 0.2 to 2 milliseconds (ms). Short integration times can lead to noisy phase images, while longer ones can lead to issues with image distortion, such as blurring. Taking into account the time needed to transfer phase image data from the image sensor 104 to internal memory of the image processor 102, a full cycle for collecting all four correlation values may take up to 20 ms or more.

A conventional depth imager based on the ToF techniques described above accumulates the N phase images associated with a given depth frame and generates the corresponding depth image based on those phase images. This unduly limits the rate at which depth images can be generated. As mentioned previously, embodiments of the invention overcome this drawback of conventional practice through the use of pseudoframes that are not constrained to ordinary depth frame boundaries.

Referring now to FIGS. 4A and 4B, exemplary groupings of the FIG. 3 phase images into pseudoframes are shown. Such groupings can be determined under the control of the pseudoframe grouping module 108 of image processor 102.

In the FIG. 4A example, a different grouping of the phase images into pseudoframes is formed for each new phase image captured by the image sensor 104, such that consecutive ones of the different groupings are offset from one another by a single phase image. The phase images are indicated by small boxes labeled 0, 1, 2 and 3, corresponding to the repeating sequence of the four different phases n π/2, where n=0, . . . , 3. A given set of phase images 0, 1, 2 and 3 is associated with a corresponding depth frame.

The generation of depth images is assumed to be performed in steps, with each step using a different grouping of phase images into pseudoframes. For the depth image generated at step 1, pseudoframes 1 and 2 comprising respective sets of phase images 0, 1, 2 and 3 are utilized in estimating a velocity field. These pseudoframes correspond generally to the same sets of phase images that would be considered part of respective consecutive depth frames. However, for the depth image generated at step 2, pseudoframes 1 and 2 comprising respective sets of phase images 1, 2, 3 and 0 are utilized in estimating a velocity field. These pseudoframes each have as a first phase image thereof one of the phase images that is not a first phase image of an associated depth frame, namely, phase image 1. Accordingly, the depth image can be generated at step 2 after capture of just one additional phase image beyond the initial set of four phase images.

Each of pseudoframes 1 and 2 formed for step 2 comprises multiple phase images (i.e., phase images 1, 2 and 3) associated with one depth frame and a single phase image (i.e., phase image 0) associated with a subsequent depth frame.

Such formation of different groupings of phase images into pseudoframes and corresponding generation of depth images can be repeated for additional steps beyond steps 1 and 2 illustrated in the figure, with a new depth image being generated for each additional phase image captured by the image sensor 104. Different groupings of pseudoframes are thus formed in this embodiment at a rate that is approximately the same as a rate at which individual ones of the phase images are captured.

In the FIG. 4B grouping, a different grouping of the phase images into pseudoframes is formed for every other phase image captured by the image sensor 104, such that consecutive ones of the different groupings are offset from one another by two phase images. The phase images are again indicated by small boxes labeled 0, 1, 2 and 3, corresponding to the repeating sequence of the four different phases n π/2, where n=0, . . . , 3. A given set of phase images 0, 1, 2 and 3 is associated with a corresponding depth frame.

The generation of depth images is again assumed to be performed in steps, with each step using a different grouping of phase images into pseudoframes. For the depth image generated at step 1, pseudoframes 1 and 2 comprising respective sets of phase images 0, 1, 2 and 3 are utilized in estimating a velocity field, as in the FIG. 4A example. As mentioned previously, these pseudoframes correspond generally to the same sets of phase images that would be considered part of respective consecutive depth frames. However, for the depth image generated at step 2, pseudoframes 1 and 2 comprising respective sets of phase images 2, 3, 0 and 1 are utilized in estimating a velocity field. Like the pseudoframes in step 2 of FIG. 2A, these pseudoframes each have as a first phase image thereof one of the phase images that is not a first phase image of an associated depth frame, but in this case phase image 2. Accordingly, the depth image can be generated at step 2 after capture of two additional phase image beyond the initial set of four phase images.

Each of pseudoframes 1 and 2 formed for step 2 comprises multiple phase images (i.e., phase images 2 and 3) associated with one depth frame and multiple phase images (i.e., phase images 0 and 1) associated with a subsequent depth frame.

Also as in the FIG. 4A example, such formation of different groupings of phase images into pseudoframes and corresponding generation of depth images can be repeated for additional steps beyond steps 1 and 2 illustrated in the figure, with a new depth image being generated for every other additional phase image captured by the image sensor 104. Different groupings of pseudoframes are thus formed in this embodiment at a rate that is approximately the same as a rate at which pairs of consecutive phase images are captured.

It is to be appreciated that the particular groupings, steps and other characteristics of the examples shown in FIGS. 4A and 4B are not limiting in any way, and can be varied in other embodiments. For example, different numbers of N phase images can be associated with each depth frame, and other groupings can be used to allow depth images to be generated at a rate that is higher than a rate at which sets of N phase images are captured. Also, the particular type and arrangement of information contained in a given phase image may vary from embodiment to embodiment. Accordingly, terms such as “depth frame” and “phase image” as used herein are intended to be broadly construed.

Moreover, the groupings of phase images into pseudoframes can vary over time depending upon the current level of activity detected in an imaged scene. For periods of relatively low activity in the imaged scene, a new grouping of pseudoframes is generated less frequently than it would be for periods of relatively high activity. In an arrangement of this type, the pseudoframe groupings of FIG. 4A would generally be associated with a higher level of activity than the pseudoframe groupings of FIG. 4B. The pseudoframe groupings can therefore be varied over time to achieve a dynamic balancing between computational power and latency.

The term “pseudoframe” as used herein is intended to be broadly construed to encompass these and other arrangements in which phase images are grouped in a manner that potentially differs from their grouping into depth frames. Grouping of phase images into pseudoframes may involve, for example, associating an identifier or other information with each of the phase images indicating that such phase images are part of a given pseudoframe. Numerous other grouping techniques can be used in forming pseudoframes from phase images.

In some embodiments, an optical flow algorithm is used to find movement between pixels of corresponding phase images of consecutive pseudoframes in estimating velocity fields. For example, for each pixel of the n-th phase image of the first pseudoframe, the optical flow algorithm finds the corresponding pixel of the n-th phase image of the second pseudoframe. The resulting motion vector is referred to herein as a velocity vector for the pixel. A set of such velocity vectors determined over respective pixels of an n-th phase image is an example of what is more generally referred to herein as a “velocity field.”

The notation Iₙ(x, y, t) is used below to denote the value of pixel (x,y) in the n-th phase image at time t. Under the assumption that the value of Iₙ(x, y, t) for each tracked point does not significantly change over the time period of two pseudoframes, the following equation can be used to determine the velocity of the point:

Iₙ(x+nVₓΔt,y+nV_{y}Δt,t+nΔt)=Iₙ(x+Vₓ(ΔT+nΔt),y+V_{y}(ΔT+nΔt),t+ΔT+nΔt)

where (Vₓ, V_{y}) denotes an unknown point velocity, Δt is the time between two consecutive phase images and ΔT is the time between two consecutive pseudoframes. Using Taylor series for both the left and right sides of the above equation results in the following equation for optical flow, specifying a linear system of four equations for respective values of n=0, . . . , 3:

$$\frac{\partial {I}_{n}}{\partial x} {V}_{x} + \frac{\partial {I}_{n}}{\partial y} {V}_{y} + \frac{\partial {I}_{n}}{\partial t} = 0$$

This system of equations can be solved using least squares or other techniques commonly utilized to solve optical flow equations, including by way of example pyramid methods, local or global additional restrictions, etc. A more particular example of a technique for solving an optical flow equation of the type shown above is the Lukas-Kanade algorithm, although numerous other techniques can be used. Also, the resulting estimated velocity fields can be filtered in the spatial domain in order to remove artifacts.

After the correspondence between pixels in different phase images is found, all of the phase images except for the first phase image are transformed in such a way that corresponding pixels have the same coordinates in all phase images.

Assume by way of example that movement of a given point has been determined as a velocity for pixel (x, y) of the first phase image and the value of this velocity is (Vₓ, V_{y}). This means that if the point has coordinates (x, y) at time T₀, then at time T₀′ its coordinates will be (x+Vₓ, y+V_{y}) and at time Tₙ its coordinates will be (x+Vₓ·n·Δt/ΔT, y+V_{y}·n·Δt/ΔT). Accordingly, transformation of the phase images other than the first phase image can be implemented by constructing corrected phase images Jₙ(x,y), where

Jₙ(x,y)=Iₙ(x+Vₓ·n·Δt/ΔT,y+V_{y}·n·Δ/ΔT).

In this example, the first phase image acquired at time T₀ is the phase image relative to which the other phase images are transformed. However, in other embodiments any particular one of the phase images can serve as the reference phase image relative to which all of the other phase images are transformed.

Also, the above-described phase image transformation can be straightforwardly generalized to any moment in time. Accordingly, acquisition time of the n-th phase image is utilized in the present embodiment by way of example only, although in some cases it may also serve to slightly simplify the computation. Other embodiments can therefore be configured to transform all of the phase images, rather than all of the phase images other than a reference phase image.

The term “acquisition time” as used herein is intended to be broadly construed, and may refer, for example, to a particular instant in time at which capture of a given phase image is completed, or to a total amount of time required to capture the phase image. The acquisition time is referred to elsewhere herein as “capture time,” which is also intended to be broadly construed.

It should be also noted that some pixels of Jₙ(x,y) may be undefined after the above-described phase image adjustment. For example, the corresponding pixel may have left the field of view of the depth imager 100, or an underlying object may become visible after a foreground object is moved.

Any of a wide variety of techniques can be used to address these missed pixels. For example, one or more such pixels can each be set to a predefined value and a corresponding flag set to indicate that the data in that particular pixel is invalid and should not be used in computation of depth and amplitude values.

As another example, the image processor 102 can store previous frame information to be used in repairing missed pixels. This may involve storing a single previous frame and substituting all missed pixels in the current frame with respective corresponding values from the previous frame. Averaged depth frames may be used instead, and stored and updated by the image processor 102 on a regular basis. It is also possible to use various filtering techniques to fill the missed pixels. For example, an average value of multiple valid neighboring pixels may be used. Again, the above missed pixel filling techniques are just examples, and other techniques or combinations of multiple techniques may be used.

Another illustrative embodiment of the invention in which depth images are generated utilizing pseudoframes will now be described with reference to FIG. 5. In this embodiment, a depth imager 500 comprises a first portion 502 which is assumed to be clocked by an image sensor and a second portion 504 that is assumed to be clocked by an external clock or possibly by application requests. The first portion comprises a phase image store 506 and a velocity field store 508, implemented using one or more memories. This embodiment utilizes depth image generation techniques similar to those described previously in conjunction with the process 200 of FIG. 2 but further incorporates velocity field filtering functionality in order to reduce artifacts and other errors in velocity field estimation attributable to rapid changes in direction of movement. More particularly, this embodiment utilizes a look-ahead technique to filter estimated velocity fields based on both previous and subsequent estimated velocity fields, at the cost of additional latency in the depth image generation.

Referring now to the first portion 502 of the depth imager 500, a phase image is obtained in block 510 and filtered in block 512. The phase image filtering in the present embodiment is implemented on a per-pixel basis in accordance with the following equation:

ν_{filtered}(x,y)=k(x,y)·ν_{raw}(x,y)+b(x,y)

where k (x, y) and b (x, y) denote normalizing coefficients. Such normalizing coefficients can be computed once for a given type of image sensor, possibly using a planar white wall perpendicular to an optical axis of the image sensor as a reference scene. The filtering provided by the equation above can be supplemental with additional filtering such as, for example, median, Gaussian or bilateral filtering. Numerous other types of filtering in any combination may be applied in other embodiments.

The filtered phase images from block 512 are stored in phase image store 506 and provided to a velocity field estimation block 514. The phase image store 506 need only store a designated number of phase images as required for performing subsequent operations such as grouping of phase images into pseudoframes, estimating velocity fields and computing time-aligned phase images. For example, with reference to the arrangement of FIG. 4A, only eight consecutive phase images need to be stored to perform processing associated with pseudoframes 1 and 2 at each of steps 1 and 2. More generally, 2N phase images can be stored in embodiments in which each depth frame is associated with a set of N phase images. Older phase images can be automatically overwritten by newer ones, possibly using a ring buffer or other similar memory arrangement. Other embodiments can store more or fewer phase images based on factors such as the manner in which such phase images are to be grouped into pseudoframes and the manner in which velocity fields are estimated from the pseudoframes.

The velocity field estimation block 514 utilizes pairs of pseudoframes such as those illustrated in each step of FIGS. 4A and 4B to generate corresponding velocity field estimates in the manner described above. The resulting estimated velocity fields are stored in the velocity field store 508.

The estimated velocity fields are then filtered in velocity field filter block 516 using the above-noted look-ahead technique. This is a type of time domain filtering, in contrast to the spatial domain filtering of velocity fields referred to elsewhere herein. An exemplary implementation of this technique will now be described in more detail. Let Tⱼ denote acquisition time of a j-th phase image where j is a positive integer specifying an absolute number of the phase image in a phase image sequence, such that j varies from 0 to infinity. If (Vₓ(Tₘ), V_{y}(Tₘ)) are respective x and y components of a velocity field at a current time Tₘ, then the corresponding filtered components of the velocity field are computed as follows:

Vₓ^{new}(Tₘ)=Fₓ(Vₓ(T_{m-K}), . . . ,Vₓ(Tₘ), . . . ,Vₓ(T_{m+L}),V_{y}(T_{m-K}), . . . ,V_{y}(Tₘ), . . . ,V_{y}(T_{m+L})),

V_{y}^{new}(Tₘ)=F_{y}(Vₓ(T_{m-K}), . . . ,Vₓ(Tₘ), . . . ,Vₓ(T_{m+L}),V_{y}(T_{m-K}), . . . ,V_{y}(Tₘ), . . . ,V_{y}(T_{m+L})).

In the above equations, Fₓ and F_{y} denote filter functions for the respective x and y components of the velocity field, K denotes history depth and L denotes look-ahead depth. By way of example, the filter functions Fₓ and F_{y} can be implemented as independent quadratic polynomials with K=L=1, although other parameters can be used. The history depth K and look-ahead depth L illustratively provide a sliding window about the current time Tₘ for filtering of the velocity fields. The velocity field filtering can advantageously implement the look-ahead technique while maintaining additional latency at an amount less than an acquisition time of a full depth frame.

As is apparent from the above velocity field filtering equations, this embodiment utilizes both previous and subsequent velocity fields relative to the current velocity field. Other embodiments can utilize only previous velocity fields and no subsequent velocity fields, or only subsequent velocity fields and no previous velocity fields.

It was noted above that the first portion 502 of the depth imager 500 is assumed to be clocked by an image sensor. Thus, the operations performed in this portion are illustratively performed in synchronization with an image sensor clock signal and therefore in synchronization with capture of phase images by the image sensor. Accordingly, with each generated phase image, blocks 510, 512, 514 and 516 are active, possibly in accordance with the exemplary pseudoframe groupings illustrated in FIG. 4A.

The second portion 504 is assumed to be clocked by an external clock or by application requests, and therefore need not operate in synchronization with the image sensor clock or in synchronization with capture of phase images by the image sensor. Instead, this portion can generate depth images at a variety of different rates as required by applications or other implementation factors. The external clock or application requests can set the depth and amplitude image output rate in this embodiment.

The second portion illustratively includes processing blocks 520, 522, 524 and 526, which correspond generally to steps 208, 210, 212 and 214 of the process 200 previously described in conjunction with FIG. 2. The time instant T_{cur} is selected under the control of the external clock or application request that sets the depth and amplitude image output rate. The time instant T_{cur} should be sufficiently close to the time of evaluation of the current velocity field at time Tₘ in the first portion 502 taking into account any look-ahead depth of the velocity field filtering performed in block 516.

A given set of time-aligned phase images are illustratively phase images associated with a particular pseudoframe and therefore need not be associated with a single depth frame but can instead be associated with different depth frames, for example, as illustrated for pseudoframes 1 and 2 in step 2 of FIG. 4A.

Alternatively, the set of phase images to be modified based on the filtered velocity field can be those of the last complete depth frame closest in time to the selected time instant T_{cur} or possibly the N phase images closest in time to T_{cur} without regard to their positions in associated depth frames. The fact that the set of phase images need not start from phase τ₀ should be taken into account in the depth image computation.

It should be appreciated that the external clock in the FIG. 5 embodiment is completely independent of the image sensor clock and thus the second portion 504 can generate depth images at an output frame rate that is higher than an input frame rate associated with phase image acquisition. For example, in this particular embodiment the output frame rate can be multiple times higher than the input frame rate.

Such an arrangement generally involves using the same pseudoframe more than once. For example, as multiple phase images are modified such that each corresponds to a particular moment in time, two different moments of time may be used within the same pseudoframe, resulting in two different depth images being generated using that pseudoframe. As a result, the output frame rate in this example will be twice as high as the input frame rate. The output frame rate can similarly be set to other multiples of the input frame rate, limited only by application need and availability of sufficient computational power.

The FIG. 5 embodiment can also achieve a fixed constant depth frame rate even in situations in which the time differences between consecutive phase images are not equal due to issues in the image sensor or data transfer mechanism. Moreover, this embodiment can respond with minimal latency to application requests for output depth images determined for particular specified time instants.

At least portions of the image processing in the FIG. 5 embodiment can be pipelined in a straightforward manner. For example, certain processing operations can be executed at least in part in parallel with one another, thereby reducing the overall latency of the process for a given depth image, and facilitating implementation of the described techniques in real-time image processing applications. Also, vector processing in firmware can be used to accelerate at least portions of one or more of the processing operations.

It is also to be appreciated that the particular processing operations used in the embodiment of FIG. 5 and other embodiments described above are exemplary only, and alternative embodiments can utilize different types and arrangements of image processing operations. For example, the particular techniques used to determine velocity fields and for transforming or otherwise modifying phase images based at least in part on the determined velocity fields can be varied in other embodiments.

In addition, other embodiments of the invention can be configured to provide only depth images and no amplitude images. For example, with reference to the embodiments of FIGS. 2 and 5, portions associated with amplitude data processing can be eliminated in embodiments in which an image sensor outputs only depth data and not amplitude data. Accordingly, the processing of amplitude data in FIGS. 2 and 5 and elsewhere herein may be viewed as optional in other embodiments.

It should again be emphasized that the embodiments of the invention as described herein are intended to be illustrative only. For example, other embodiments of the invention can be implemented utilizing a wide variety of different types and arrangements of image processing circuitry, modules and processing operations than those utilized in the particular embodiments described herein. In addition, the particular assumptions made herein in the context of describing certain embodiments need not apply in other embodiments. These and numerous other alternative embodiments within the scope of the following claims will be readily apparent to those skilled in the art.

What is claimed is:

1. A method comprising:
obtaining phase images;
grouping the phase images into pseudoframes with each of at least a subset of the pseudoframes comprising multiple ones of the phase images and having as a first phase image thereof one of the phase images that is not a first phase image of an associated depth frame;
estimating a velocity field by comparing corresponding phase images in respective consecutive ones of the pseudoframes;
modifying phase images of one or more pseudoframes based at least in part on the estimated velocity field; and
generating one or more depth images based at least in part on the modified phase images;
wherein said obtaining, grouping, estimating, modifying and generating are implemented in at least one processing device comprising a processor coupled to a memory.

2. The method of claim 1 wherein grouping the phase images into pseudoframes comprises forming a different grouping of the phase images into pseudoframes for each obtained phase image such that consecutive ones of the different groupings are offset from one another by a single phase image.

3. The method of claim 1 wherein grouping the phase images into pseudoframes comprises forming a different grouping of the phase images into pseudoframes for every other obtained phase image such that consecutive ones of the different groupings are offset from one another by two phase images.

4. The method of claim 1 wherein grouping the phase images into pseudoframes comprises forming a given pseudoframe utilizing multiple phase images associated with a first depth frame and a single phase image associated with a second depth frame.

5. The method of claim 1 wherein grouping the phase images into pseudoframes comprises forming a given pseudoframe utilizing at least one phase image associated with a first depth frame and multiple phase images associated with a second depth frame.

6. The method of claim 1 wherein each depth frame is associated with a corresponding set of N phase images and grouping the phase images into pseudoframes comprises forming pseudoframes at a rate that is higher than a rate at which sets of N phase images are captured.

7. The method of claim 1 wherein grouping the phase images into pseudoframes comprises forming pseudoframes at a rate that is approximately the same as a rate at which individual ones of the phase images are captured such that a new set of pseudoframes is formed for each new phase image that is captured.

8. The method of claim 1 wherein estimating a velocity field comprises, for each of a plurality of pixels of a given one of the phase images of a first one of the pseudoframes, determining an amount of movement of a point of an imaged scene between the pixel of the given phase image of the first pseudoframe and a pixel of a corresponding phase image of a second one of the pseudoframes.

9. The method of claim 8 wherein determining an amount of movement comprises determining a velocity (Vₓ, V_{y}) of a point of the imaged scene corresponding to pixel (x,y) of the given phase image.

10. The method of claim 8 wherein modifying phase images of one or more pseudoframes based at least in part on the estimated velocity field comprises adjusting pixel values of respective other phase images of the first pseudoframe based on the determined amount of movement.

11. The method of claim 10 wherein adjusting pixel values of respective other phase images of the first pseudoframe comprises transforming the other phase images such that the point of the imaged scene has substantially the same pixel coordinates in each of the phase images of the first pseudoframe.

12. The method of claim 1 wherein the pseudoframes comprise respective sequences of at least four consecutive phase images each having a different capture time.

13. The method of claim 1 wherein generating one or more depth images comprises generating depth images at an output frame rate that is greater than an input frame rate associated with phase image acquisition.

14. An apparatus comprising:
at least one processing device comprising a processor coupled to a memory;
wherein said at least one processing device is configured:
to obtain phase images;
to group the phase images into pseudoframes with each of at least a subset of the pseudoframes comprising multiple ones of the phase images and having as a first phase image thereof one of the phase images that is not a first phase image of an associated depth frame;
to estimate a velocity field by comparing corresponding phase images in respective ones of the pseudoframes;
to modify phase images of one or more pseudoframes based at least in part on the estimated velocity field; and
to generate one or more depth images based at least in part on the modified phase images.

15. The apparatus of claim 14 wherein said at least one processing device is configured to group the phase images into pseudoframes by:
forming a different grouping of the phase images into pseudoframes for each obtained phase image such that consecutive ones of the different groupings are offset from one another by a single phase image.

16. The apparatus of claim 14 wherein said at least one processing device is configured to group the phase images into pseudoframes by:
forming a different grouping of the phase images into pseudoframes for every other obtained phase image such that consecutive ones of the different groupings are offset from one another by two phase images.

17. The apparatus of claim 14 wherein said at least one processing device is configured to group the phase images into pseudoframes by:
forming a given pseudoframe utilizing multiple phase images associated with a first depth frame and a single phase image associated with a second depth frame.

18. A depth imager comprising:
an image sensor; and
an image processor coupled to the image sensor;
wherein the image processor is configured:
to obtain phase images;
to group the phase images into pseudoframes with each of at least a subset of the pseudoframes comprising multiple ones of the phase images and having as a first phase image thereof one of the phase images that is not a first phase image of an associated depth frame;
to estimate a velocity field by comparing corresponding phase images in respective ones of the pseudoframes;
to modify phase images of one or more pseudoframes based at least in part on the estimated velocity field; and
to generate one or more depth images based at least in part on the modified phase images.

19. The depth imager of claim 18 wherein the image processor is configured to estimate a velocity field by comparing corresponding phase images in respective ones of the pseudoframes by:
for each of a plurality of pixels of a given one of the phase images of a first one of the pseudoframes, determining an amount of movement of a point of an imaged scene between the pixel of the given phase image of the first pseudoframe and a pixel of a corresponding phase image of a second one of the pseudoframes.

20. The depth imager of claim 18 wherein the pseudoframes comprise respective sequences of at least four consecutive phase images each having a different capture time.
